(19) United States
(12) Patent Application Publication
(10) Pub. No.: US 2023/0274195 A1
(43) Pub. Date: Aug. 31, 2023

(54) TIME-VARYING FEATURES VIA METADATA

(71) Applicant: Oracle International Corporation, Redwood Shores, CA (US)

(72) Inventors: Ankit Kumar Aggarwal, Mumbai (IN); Vikas Pandey, Bengaluru (IN); Praneet Pabolu, Bangalore (IN); Samik Raychaudhuri, Bangalore (IN)

(73) Assignee: Oracle International Corporation, Redwood Shores, CA (US)

(21) Appl. No.: 17/854,482

(22) Filed: Jun. 30, 2022

Related U.S. Application Data
(60) Provisional application No. 63/314,841, filed on Feb. 28, 2022.

(51) Int. Cl. G06N 20/20

(52) U.S. Cl. CPC G06N 20/20

(57) ABSTRACT

The present embodiments relate to using feature engineering to generate time-varying features via metadata. A first exemplary embodiment provides a method for performing feature engineering to generate time-varying features. The method can include receiving a first value and a second value of the time-series data. The method can further include receiving metadata that describes a relationship between the first value and the second value. The method can further include detecting the relationship between the first value and the second value based on the metadata. The method can further include generating, a time-varying feature from a combination of the first value and the second value based on the relationship detected from the metadata. The method can further include generating, by implementing the machine learning forecasting model, a forecasted value for the time-series data based on the time-varying feature.

### CROSS-REFERENCE TO RELATED APPLICATIONS

This application claims the benefit of prior filed U.S. Provisional Patent Application No. 63/314,841, filed Feb. 28, 2022, which is hereby incorporated by reference herein in its entirety.

### BACKGROUND

A cloud service provider (CSP) can provide multiple cloud services to subscribing customers. These services are provided under different models, including a Software-as-a-Service (SaaS), Platform-as-a-Service (PaaS), an Infrastructure-as-a-Service (IaaS) model, and others.

Within the CSP, some services are based on forecasting models that apply machine learning techniques to forecast future values. Traditionally, these machine learning forecasting techniques rely on processing multivariate data to create static features. However, these techniques fail to discover more complex time-based relationships within the input data.

### BRIEF SUMMARY

The present embodiments relate to using feature engineering to generate time-varying features via metadata. A first exemplary embodiment provides a method for performing feature engineering to generate time-varying features. The method can include receiving a first value associated with a first time step of a time-series data and a second value associated with a second timestep of the time-series data.

The method can further include receiving metadata that describes a relationship between the first value associated with the first time step of the time-series data and the second value associated with the second time step of the time-series data, the metadata being generated based on the time-series data.

The method can further include detecting the relationship between the first value associated with the first time step of the time-series data and the second value associated with the second time step of the time-series data based on the metadata.

The method can further include generating, via feature engineering, a time-varying feature from a combination of the first value associated with the first time step of the time-series data and the second value associated with the second time step of the time-series data based on the relationship detected from the metadata.

The method can further include receiving an exogenous data value, the exogenous data value being generated distinctly from the time-series data.

The method can further include generating an input data value for a machine learning forecasting model by applying the exogenous data value to the time-varying feature.

The method can further include generating, by implementing the machine learning forecasting model, a forecasted value for the time-series data based on the input data value.

A second exemplary embodiment relates to a cloud infrastructure node. The cloud infrastructure node can include a processor and a non-transitory computer-readable medium. The non-transitory computer-readable medium can include instructions that, when executed by a processor, cause the processor to receive a first value associated with a first time step of a time-series data and a second value associated with a second timestep of the time-series data.

The instructions can further cause the processor to receive metadata that describes a relationship between the first value associated with the first time step of the time-series data and the second value associated with the second time step of the time-series data, the metadata being generated based on the time-series data

The instructions can further cause the processor to detect the relationship between the first value associated with the first time step of the time-series data and the second value associated with the second time step of the time-series data based on the metadata.

The instructions can further cause the processor to generate, via feature engineering, a time-varying feature from a combination of the first value associated with the first time step of the time-series data and the second value associated with the second time step of the time-series data based on the relationship detected from the metadata.

The instructions can further cause the processor to receive an exogenous data value, the exogenous data value being generated distinctly from the time-series data.

The instructions can further cause the processor to generate an input data value for a machine learning forecasting model by applying the exogenous data value to the time-varying feature.

The instructions can further cause the processor to generate, by implementing the machine learning forecasting model, a forecasted value for the time-series data based on the input data value.

A third exemplary embodiment relates to a non-transitory computer-readable medium. The non-transitory computer-readable medium can include stored thereon a sequence of instructions, which, when executed by a processor, cause the processor to execute a process. The process can include receiving a first value associated with a first time step of a time-series data and a second value associated with a second timestep of the time-series data.

The process can further include receiving metadata that describes a relationship between the first value associated with the first time step of the time-series data and the second value associated with the second time step of the time-series data, the metadata being generated based on the time-series data.

The process can further include detecting the relationship between the first value associated with the first time step of the time-series data and the second value associated with the second time step of the time-series data based on the metadata.

The process can further include generating, via feature engineering, a time-varying feature from a combination of the first value associated with the first time step of the time-series data and the second value associated with the second time step of the time-series data based on the relationship detected from the metadata.

The process can further include receiving an exogenous data value, the exogenous data value being generated distinctly from the time-series data.

The process can further include generating an input data value for a machine learning forecasting model by applying the exogenous data value to the time-varying feature.

The process can further include generating, by implementing the machine learning forecasting model, a forecasted value for the time-series data based on the input data value.

### BRIEF DESCRIPTION OF THE DRAWINGS

FIG. 1 is a block diagram of an exemplary network environment, according to at least one embodiment.

FIG. 2 is a simplified block diagram of a feature engineering path according to one or more embodiments.

FIG. 3 is a simplified drawing of a machine learning model for forecasting according to one or more embodiments.

FIG. 4 is an exemplary time-series data table according to one or more embodiments.

FIG. 5 is an exemplary metadata data table according to one or more embodiments.

FIG. 6 is an exemplary time-varying features table according to one or more embodiments.

FIG. 7 is an exemplary time-varying series data table according to one or more embodiments.

FIG. 8 is an exemplary time-shifted feature table according to one or more embodiments.

FIG. 9 is an exemplary rolling mean value features table according to one or more embodiments.

FIG. 10 is an exemplary directional features table according to one or more embodiments.

FIG. 11 is a block diagram illustrating an exemplary method for time-varying feature generation according to one or more embodiments.

FIG. 12 is a block diagram illustrating a pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating an example computer system, according to at least one embodiment.

### DETAILED DESCRIPTION

In the following description, various examples will be described. For the purposes of explanation, specific configurations and details are set forth to provide a thorough understanding of the examples. However, it will also be apparent to one skilled in the art that the examples may be practiced without the specific details. Furthermore, well-known features may be omitted or simplified in order not to obscure the example being described.

Machine learning systems can be configured to include a framework for time-series forecasting. Time-series forecasting can involve using predictive machine learning models to receive input data and output forecasted values derived from features observed in the data. In other words, historical time-series data values can be used to predict future data values. To simplify calculations, many computing systems perform univariate forecasting. In this approach, a computing system extracts static features from time-series data and does not consider any related time-series metadata. The computing system can receive a set of time-series data and can analyze the data to statically forecast future values. However, by not extracting time-varying features from the metadata, the computing system fails to detect certain influences that one set of time-series data can have on another set of time-series data.

Embodiments described herein include cloud computing devices that combine time-series data with metadata to extract novel multivariate features that are better suited as forecasting inputs than traditional univariate features. A cloud computing device can receive time-series data and metadata from an external or internal source. The cloud computing device can combine the time-series data and the metadata to extract time-varying features from the combination. The time-varying features can be further combined with additional exogenous data to generate input data for a machine learning forecasting model. The cloud computing device can implement the machine learning forecasting model and forecast values. As the forecasted values rely on multivariate time-varying features, the forecasted values are more accurate than those that rely on static features.

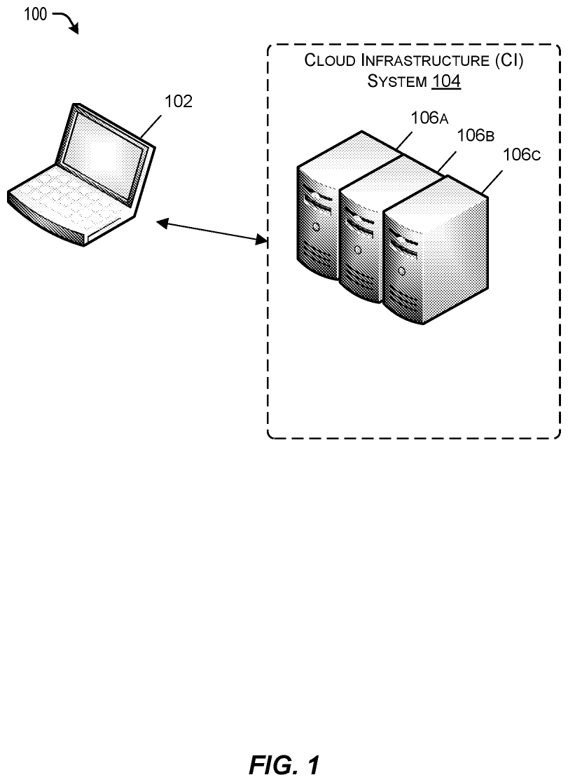

Referring to FIG. 1, a block diagram of an exemplary network environment 100 according to one or more embodiments is shown. The network environment 100 is operable to permit data communication between devices within the network environment 100 using one or more wired or wireless networks. As illustrated in FIG. 1, the network environment 100 includes a console 102 and a cloud infrastructure (CI) system 104 (including corresponding computing devices 106a-c). A computing device 106a of the CI system 104 can be used to execute a machine learning forecasting model that forecasts values based on data interdependencies described in time-varying features.

The console 102 can include a laptop computer with an operating system that is operable to communicate with the CI system 104. The console 102 can provide the computing device 106a with time-series data and instruct the computing device 106a to forecast values from the time-series data. The computing device 106a can reframe the time-series data as data set for a machine learning forecasting model. The machine learning algorithm can further execute the machine learning forecasting model to generate the forecasted values.

The CI system 104 can include one or more interconnected computing devices implementing one or more cloud computing applications or services. For example, the CI system 104 can store and provide access to database data (e.g., via a query of the database). The computing devices 106a-c included in the CI system 104 can be in one or more data center environments (e.g., colocation centers).

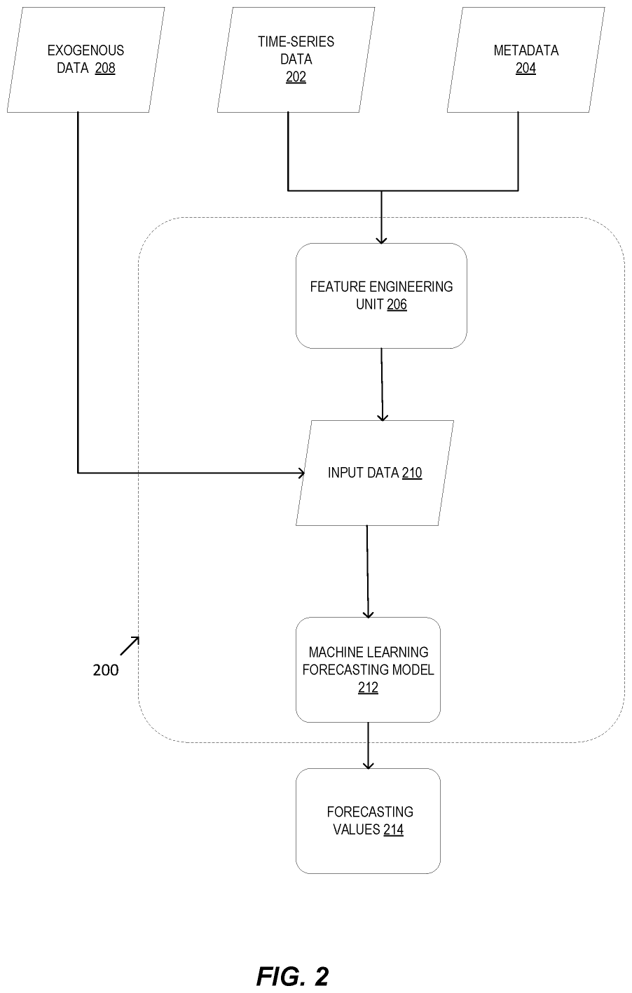

Referring to FIG. 2, a machine learning framework 200 implemented by a computing device (e.g., computing device 106a) is shown according to embodiments. A time-series data 202 can be time-series data set that includes data recorded over multiple periods of time. The time-series data 202 can further be the data used as a basis for forecasting by the machine learning framework 200. For example, the time-series data 202 can include server performance parameter values for January to December of a particular year. The computing device can be tasked with forecasting server performance parameter values for January and February of the following year. The metadata 204 can be metadata that describes the values of the time-series data 202. For example, the metadata 204 can be the names of one or more clients assigned to the server and influence the server performance parameter values.

The feature engineering unit 206 can receive the time-series data 202 and the metadata 204 and perform the feature engineering to generate time-varying features as described below. In particular, the feature engineering unit 206 can transform the time-series data 202 and the metadata 204 to time-varying features that are better suited for forecasting values for the time-series data 202. Through feature engineering, the machine learning framework 200 can improve the quality of the forecasting results as opposed to feeding a machine learning model raw data or relying on univariate features. In embodiments, the time-varying features can be multivariate features that use the relationships described in the metadata 204 to describe interdependences between the values of the time-series data 202. For example, the feature engineering unit 206 can combine values from the time-series data 202 based on interdependences discovered through the metadata 204 that the values relate to the same client. This contrasts with univariate techniques that only rely on time-series data without relying on metadata. In these cases, the metadata can be ignored, and therefore any relationship based on the client would not have been discovered.

The feature engineering unit 206 can combine the time-series data 202 and the metadata 204 to create time-vary features that are not present in the time-series data 202 or the metadata 204. The feature engineering unit 206 can extract values from the time-series data 202. The feature engineering unit 206 can further define the extracted values using the metadata 204. The feature engineering unit 206 can sub-divide the time-series data 202 and the metadata 204 based on respective time-series instances. The feature engineering unit 206 can further associate individual time-series from the time-series data 202 with individual time-series from the metadata 204. For example, a first time-series of the metadata 204 may describe a first time-series of the time-series data 202. In this case, the feature engineering unit 206 associates the first time-series of the metadata 204 with the first time-series of the time-series data 202. By associating the two time-series, the feature engineering unit 206 provides context, via the metadata 204, to the first time-series of the time-series data 202.

The feature engineering unit 206 can further create time-varying features based on the combination of the time-series data 202 and the metadata 204. The time-varying features can include different combinations of values from the time-series data 202 based on the metadata 204. Specific examples of time-varying features are described with more particularity with respect to FIGS. 5-10.

The time-vary features can be combinations of two or more values from the time-series data 202 that present information not expressly described by the time-series data 202 prior to feature engineering. In some embodiments, the time-varying features can further include combinations and comparisons of values of the time-series data 202 based on lags. Lags can be the number of time steps between values of the time-series data 202. For example, consider a time-series that included data from Jan. 1, 1990, Feb. 1, 1990, and Mar. 1, 1990. In this example, a lag can be one. With a lag of one, the data from Jan. 1, 1990, can be combined with or compared to data from Feb. 1, 1990, and the data from Feb. 1, 1990, can be combined with or compared to data from Mar. 1, 1990. In another example, the lag can be 2. In this instance, the data from Jan. 1, 1990, can be combined with or compared to data from Mar. 1, 1990. The feature engineering unit 206 determines an optimal lag based on the time-series data 202 based on the metadata 204. For example, the time-series data 202 can be daily data, in which case any lag greater than one may not yield informative results. The time-series data 202 can be quarterly data, in which case a larger lag may still yield informative results. It should be appreciated that not every time-varying feature can be traceable back from a forecasting output of a machine learning model. The time-varying features are provided to a machine learning forecasting model, and the machine learning forecasting model selects the time-varying features that lead to the top-performing machine learning forecasting models.

The computing device can receive the exogenous data 208 and the generated time-varying features from the feature engineering unit 206. The computing device can further combine the exogenous data 208 and the generated time-varying features to create input data 210. The exogenous data 208 can be data that is not influenced by the time-series data 202. However, the exogenous data 208 can influence the time-series data 202. Returning to the server example, the exogenous data 208 can be, for example, gross domestic product. A server's performance cannot influence the gross domestic product. However, an increasing gross domestic product can be a sign that more goods and services are being created. The greater number of goods and services that can be created can lead to an increase in demand for the server's resources. As illustrated by the example, the exogenous data 208 can be generated distinctly from the time-series data 202. The computing device can create the input data 210 similarly to creating the time-varying features.

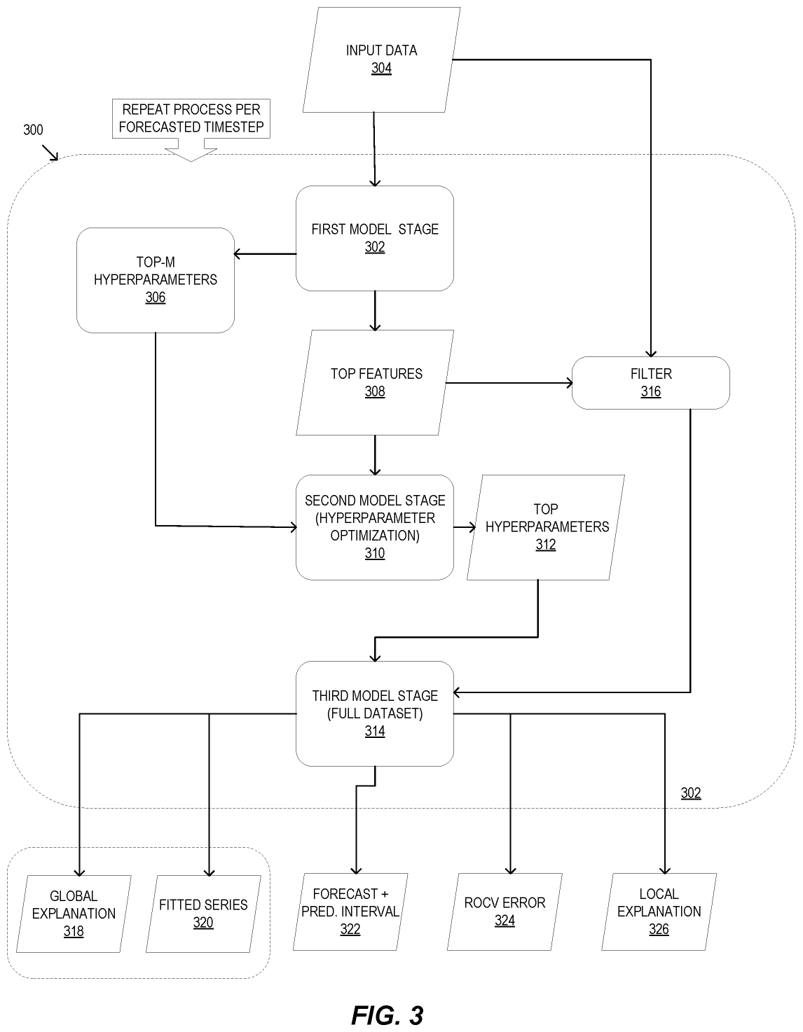

The computing device can receive the input data 210 and implement a machine learning forecasting model 212 to output forecasting values 214. The machine learning forecasting model 212 can be a set of algorithms that are trained to recognize certain patterns in the time-series data 202 and the metadata 204. The machine learning forecasting model 212 can further apply the patterns to generate forecasted values for the time-series data 202. For example, the time-series data 202 can be yearly data from 2015 to 2022, the machine learning forecasting model 212 can forecast values for 2023-2025. The machine learning forecasting model 212 can be implemented by, for example, a neural network. In some embodiments, the machine learning forecasting model 212 can implement a gradient boosting technique. Gradient boosting can be a technique in which the learning process includes fitting new machine learning models to generate more accurate results. An exemplary machine learning forecasting model 212 is described with more particularity with respect to FIG. 3.

Referring to FIG. 3, a machine learning forecasting model framework 300 is shown according to embodiments. The machine learning forecasting model framework 300 includes software and hardware that can be implemented by the computing device (e.g., computing device 106a) to generate forecasted values for time-series data. The machine learning forecasting model framework 300 can process through multiple stages to generate the forecasted values for the time-series data. Each stage of the machine learning forecasting model framework 300 can be repeated. If the number of total forecasted timesteps is “H”, then each stage of the machine learning forecasting model can be repeated “H” times. For example, a user can provide time-series data, including one hundred time steps (e.g., T₀, . . . , T₉₉). The machine learning forecasting model framework 300 can be configured to forecast values for the next five time steps (e.g., T₁₀₀, . . . , T₁₀₄). In this example, “H” would be equal to the number of desired forecasted values or five. Therefore, the machine learning forecasting model framework 300 can repeat each stage of the machine learning forecasting model five times to generate the five forecasted values.

At the first model stage 302, the machine learning forecasting model framework 300 can receive input data 304 for processing. The input data 304 can be a combination of exogenous data and time-varying features. The machine learning forecasting model framework 300 can further include hyperparameters. Hyperparameters can be parameters whose values are used to control the training process and help determine the values of the machine learning forecasting model parameters. Examples of hyperparameters include but are not limited to, a number of clusters in a clustering task, training data vs. testing data ratio, pooling size, and batch size.

The training data can be data that is used to train a machine learning forecasting model, and the test data can be the data used to test the forecasting accuracy of the machine learning forecasting model. For example, a training data vs. testing data ratio can be 95:5. For time-series data, the division between training data and testing data can be, for example, based on the time steps. Consider a time-series including values from twelve time steps (e.g., Jan. 1, 2019, . . . , Dec. 1, 2019). The training data can include data from the first ten time steps (e.g., Jan. 1, 2019, . . . , Oct. 1, 2019) and the testing data can include data from the last two time steps (e.g., Nov. 1, 2019, and Dec. 1, 2019). In some instances, the training data can further be subdivided into a training set and a validation set. The machine learning forecasting model framework 300 can receive the hyperparameters and divide the input data 304 into training data and testing data. For example, if the input data 304 included five time-series data of length one hundred each. The machine learning forecasting model framework 300 can divide each data set into a first length of ninety-five for the training data and a second length of five for the test data, totaling one hundred. Therefore, the training data includes four hundred and seventy-five data instances (ninety-five*five), and the testing data includes twenty-five data instances (five*five).

The machine learning forecasting model framework 300 can then apply the training data portion of the input data 304 to machine learning model instances for training purposes. The machine learning forecasting model framework 300 can receive a set of hyperparameters to use during the training process. For each machine learning model instance, the machine learning forecasting model framework 300 can implement random subsets of hyperparameters to help determine which hyperparameters lead to the most accurate trained machine learning forecasting models. The machine learning forecasting model framework 300 can further train the machine learning forecasting model instances using different samples of the training data. Different samples of training data can include different time-varying features. Therefore, the different machine learning forecasting model instances can be trained with different combinations of hyperparameters and time-varying features.

The machine learning forecasting model framework 300 can then validate the trained machine learning model instances using the validation data portion of the training data. The machine learning forecasting model framework 300 can then apply the testing data to the validated machine learning forecasting model instances to measure the accuracy of the models. For example, in some instances, the machine learning forecasting model framework 300 applies a cost function (e.g., a regression cost function, a binary classification cost function, or multi-classification cost function). The cost function enables the machine learning forecasting model framework 300 to determine which machine learning forecasting model instances generated the most accurate results. By extension, the cost function enables the computing device to determine which combinations of hyperparameters and time-varying features lead to the most accurate results. Based on the results, the machine learning forecasting model framework 300 can detect the top-M hyperparameters 306. For example, if the machine learning forecasting model framework 300 had a set of twenty hyperparameters, the top-M hyperparameters can be the top-M hyperparameters implemented by the machine learning forecasting models that yielded the best results. “M” can be any user-defined number of hyperparameters for the machine learning forecasting model framework 300. The machine learning forecasting model framework 300 can further detect the top time-varying features 308. The number of detected top features 308 can be determined during the feature engineering process. For example, if the input data 304 includes two hundred time-varying features, the top time-varying features 308 can be the features used by the machine learning model instances that yielded the best results based on the cost function.

The machine learning forecasting model framework 300 can store the top-M hyperparameters 306 in memory, for example, in a cache. The machine learning forecasting model framework 300 can further store the top time-varying features 308 in memory, for example, the cache. For example, a feature engineering unit can have generated two hundred time-varying features. Based on the cost function results, the machine learning forecasting model framework 300 can select twenty of those features, as the top performing machine learning forecasting models were trained using some combination of those twenty time-varying features.

The machine learning forecasting model framework 300 can transmit the top-M hyperparameters 306 and the top time-varying features 308 to a second model stage 310. Here, the machine learning forecasting model framework 300 can implement hyperparameter optimization techniques to further determine the combination of hyperparameters of the top-M hyperparameters 306, and that leads to the most accurate forecasting results. While the first model stage 302, the machine learning forecasting model framework 300, essentially used a Bayesian optimization algorithm to determine the top-M hyperparameters 306, at the second model stage 310, the machine learning forecasting model framework 300 applies a more deliberate approach to further identify a subset of the top-M hyperparameters. At the second model stage 310, the machine learning forecasting model framework 300 can define a search space, which can be a multi-dimensional volume. Each hyperparameter can be represented as a dimension of the multi-dimensional volume. The scale of each hyperparameter can represent the values that each hyperparameter can take (e.g., real-valued, integer-valued, or categorical). Each point in the multi-dimensional volume can be a vector having a respective value for the underlying hyperparameter value. The machine learning forecasting model framework 300 can then evaluate each point in the multi-dimensional volume to determine which hyperparameters result in the most accurate forecasted values. The machine learning forecasting model framework 300 can store the top hyperparameters 312 in memory, for example, cache. The top hyperparameters 312 can be a subset of the top-m hyperparameters 306.

The machine learning forecasting model framework 300 can then proceed to the third model stage 314. The machine learning forecasting model framework 300 retrieves the top hyperparameters 312 from memory, and the top time-varying features 308 via a filter 316. The machine learning forecasting model framework 300 can use the full training data set (e.g., the training data and the testing data) to build a deployable machine learning forecasting model. The deployable machine learning forecasting model can provide a global explanation 318, a fitted series 320, a forecasted value, and prediction interval 322, a rolling-origin cross-validation error (ROCV) error 324, and a local explanation 326 for each forecasted time step. For example, the deployable machine learning forecasting model can be provided time step values for Jan. 1, 2019-Jul. 1, 2019, and can be asked to forecast values for Aug. 1, 2019, and Sep. 1, 2019, the deployable machine learning model will respectively generate a global explanation 318, a fitted series 320, a forecasted value, and prediction interval 322, an ROCV error 324, and a local explanation 326 for Aug. 1, 2019, and Sep. 1, 2019. The global explanation 318 quantifies the amount each time-varying feature contributed to all of the forecasted values together (e.g., Aug. 1, 2019, and Sep. 1, 2019). The fitted series 320 takes the forecasted values and fits the full data set to match the forecasted values. The forecasted value and the prediction interval 322 are the forecasted value and an upper bound and lower bound for the forecasted value. The ROCV error 324 can be an average of observed error values for the testing data. The local explanation 326 quantifies the amount each time-varying feature contributed to the forecasted values individually (e.g., Aug. 1, 2019, or Sep. 1, 2019).

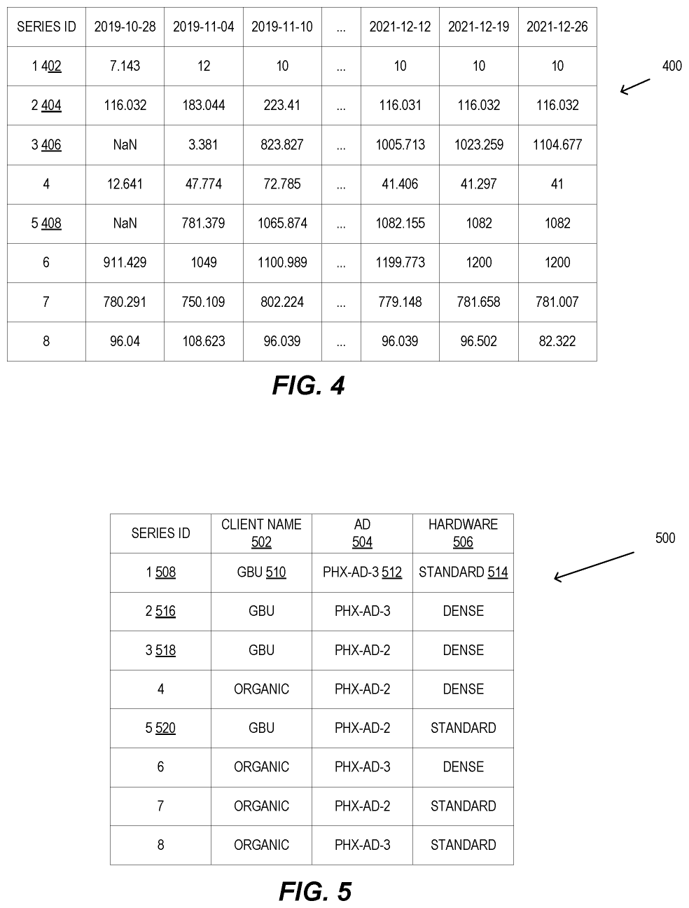

Referring to FIG. 4, an exemplary time-series data table 400 is shown according to one or more embodiments. A console (e.g., console 102) can provide a computing device (e.g., computing device 106a) a time-series data table 400 include including eight time-series. The time-series data table 400 is illustrated as a table in which each row corresponds to a time-series. In this example, the data for the time-series data table 400 can be collected each week from Oct. 28, 2019, until Dec. 26, 2021. For example, series 1 402 includes the values from Oct. 20, 2021, to Dec. 26, 2021. The computing device (e.g., computing device 106a) can be instructed to forecast data for one or more rows of the time-series data. For example, the computing device can be instructed to forecast series 1 402 values for Jan. 2, 2022, and Jan. 9, 2022. The computing device can implement a multivariate forecasting technique to detect interdependencies between the values included in the time-series data table 400. The computing device can further use the interdependencies to assist in forecasting series 1 402 values for Jan. 2, 2022, and Jan. 9, 2022.

Referring to FIG. 5, an exemplary metadata table 500 is shown according to one or more embodiments. The metadata table 500 is illustrated as a table in which each row corresponds to the same time-series as the time-series data table 400. The metadata table 500 can include values for different metadata features associated with the time-series data table 400. As illustrated, the metadata table 500 includes values for a client name 502, an available domain 504, and a hardware 506. Each series of the metadata table 500 corresponds to the same series in the time-series data table 400. For example, series 1 508 of the metadata table 500 corresponds to series 1 402 of the time-series data table 400. The computing device can use the metadata table 500 to detect interdependencies in values of the time-series data table 400. For example, by analyzing the metadata table 500, the computing device can determine that the values in series 1 402 of the time-series data table 400 belong to the client, GBU 510, the availability domain (AD) PHX-AD-3 512, and standard hardware 514. The client name 502 column of the metadata table 500 includes multiple rows that include GBU as a client (e.g., series 1 508, series 2 516, series 3 518, and series 5 520). Therefore, values included series 2 404, series 3 406, and series 5 408 of the time-series data table 400 are associated with the same client, GBU. As illustrated, the values from rows 4 and 6-8 of the time-series data table 400 are associated with another client, Organic.

The computing device can combine values from the time-series data table 400 to generate multiple time-varying features to describe interdependencies between the values. The computing device can be configured to generate time-varying features, such as rolling window aggregated features, lagged features, and direction-based features based on the time-series data table 400 and the metadata table 500.

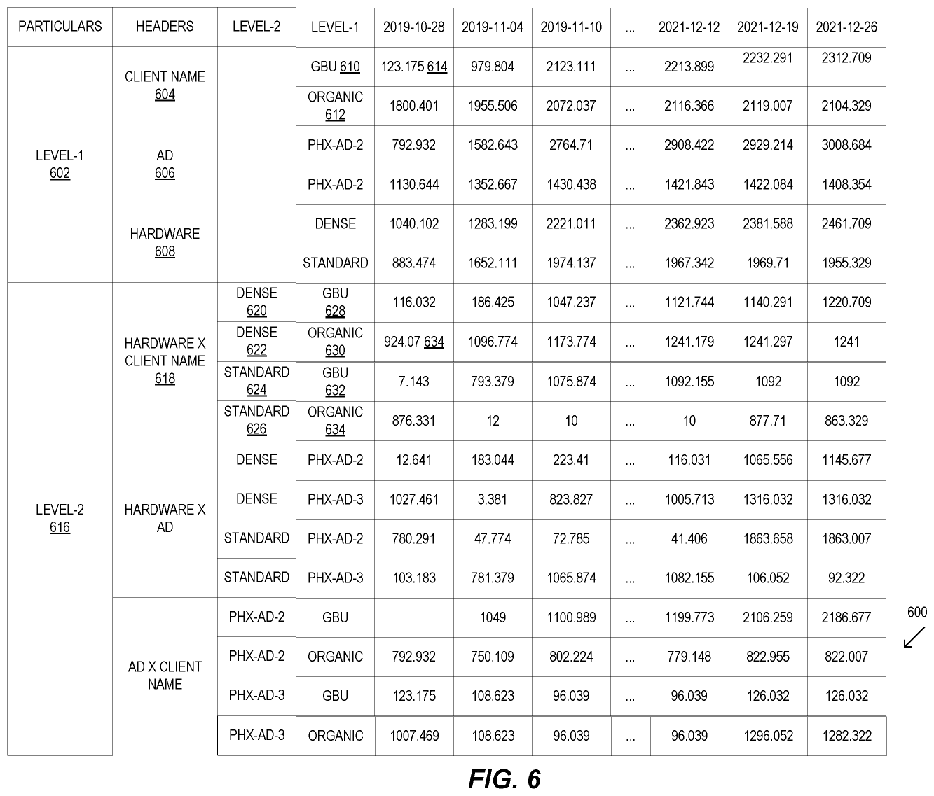

Referring to FIG. 6, a time-varying features table 600 according to embodiments is shown. The time-vary features table 600 can include time-varying features generated by combining the values from the time-series data table 400 based on interdependencies described by the metadata table 500. The time-varying features table 600 can include a row header derived from the metadata table 500. For example, the time-varying features table 600 can include a header, level-1 602, for a set of associated rows. Level-1 602 can correspond to headers derived from the columns of the metadata table 500. In this example, level-1 602 corresponds to client name 604, an AD 606, and a hardware type 608. Each of the client name 604, the AD 606, and the hardware type 608 corresponds to descriptors from the metadata table 500. For example, the header for client name 604 can correspond to GBU 610 and Organic 612, which are client names derived from the metadata table 500.

The time-varying features table 600 can further include time-vary features generated from the combination of the values of the time-series data table 400. As described earlier, data included series 2 404, series 3 406, and series 5 408 of the time-series data table 400 are associated with the same client, GBU. Therefore, one time-varying feature can be a combination of each GBU-related value. As illustrated, the column and row entry 614 for GBU 610 and Oct. 28, 2019 can be a combination of all GBU related entries for Oct. 28, 2019 from the time-series data table 400 (e.g., 7.143+116.032+NaN (i.e., 0)+NaN=123.175). Furthermore, as suggested above, this feature could not be created without a combination of the values of the time-series data table 400 and the metadata table 500.

The time-varying features table 600 can further include a header for level 2 616 for a set of associated rows. Level 2 616 can correspond to values created from combinations of more than one metadata feature (e.g., hardware x client, hardware x AD, and AD x client name). Consider, for example, the hardware x client name row 618, which corresponds to four hardware headers 620, 622, 624, and 626 and four client name headers 628, 630, 632, and 634. As illustrated, the hardware x client name row 618 corresponds to each combination of hardware and client name included in the metadata table 500 (i.e., dense+GBU, dense+organic, standard+GBU, and standard+organic). Each combination corresponds to values that are derived from values in the time-series data table 400 that relate to both hardware and client name.

Take, for instance, the Oct. 28, 2019 value 636 corresponding to the header dense 620 and Organic 628. Referring to FIG. 5, it can be seen that series 4 and series 6 are the two series that correspond to both the client's name, Organic, and the hardware type, dense. Referring to FIG. 4, the Oct. 28, 2019 value for series 4 is 12.641 and the Oct. 28, 2018 value for series 6 is 911.429. By adding the Oct. 28, 2019 value (12.641) for series 4 and the Oct. 28, 2018 value for series 6 (911.429), we reach the Oct. 28, 2019 value 636 in the time-varying features table 600 (12.641+911.429=924.07).

The number of levels in the time-varying feature table 600 can relate to the number of features of the metadata table 500. In some embodiments, the number of levels in the time-varying feature table 600 equals the number of features in the metadata table minus one. As illustrated, the metadata table 500 includes three features (client name, AD, and hardware type). Therefore, the number of levels of the time-varying feature table 600 is two (3−1=2).

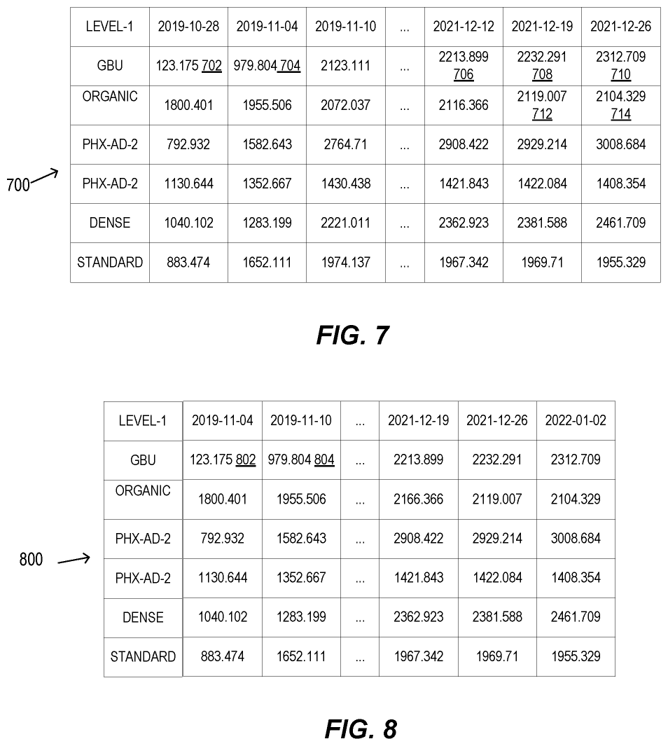

The computing device can further enrich the values in the time-varying feature table 600 by creating lagged features. Lagged features are features generated from time-series data based on a number of time steps between values. The computing device can take values, for example, from the time-varying feature table 600 and create lagged features. Referring to FIG. 7, a table 700 showing the level 1 portion of the time-varying feature table 600 is presented for illustration purposes. The time steps in the table 700 begin on Oct. 28, 2019 and end on Dec. 26, 2021. The computing device can then shift the values associated with each time step to create lagged features. Referring to FIG. 8, a table 800 is shown in which the values associated with each time step in the table 700 from FIG. 7 have been shifted right to a next time step. As seen in FIG. 8, the values from the table 700 have shifted by one time step. For example, referring to FIG. 7, the Oct. 28, 2019 value 702 for the client GBU is 123.175, and the Nov. 4, 2019 value 704 for the client GBU is 979.804. Now referring to FIG. 8, the Nov. 4, 2019 value 802 for the client GBU is 123.175, and the Nov. 11, 2019 value 804 for the client GBU is 979.804. It should be appreciated that in other embodiments, the time shift can be for greater than one time step. The time shift length can be based on the time shift interval that generates the input data best suited for a machine learning algorithm. For example, in another data set, the time shift could include shifting the values for two time steps instead of one time step, as illustrated in FIGS. 7 and 8.

The computing device can use the values from the time-varying feature table 600 to create different time-varying features. Another time-varying feature that the computing device can generate can be a multi-time step rolling mean value. In some embodiments, the number of previous time step data used to create a multi-time step rolling mean value can be based upon the number of forecasted time step values (e.g., “H”) that a machine learning forecasting model can be asked to make. For example, if the machine learning forecasting model can be tasked with predicting three time steps, the number of previous time step values used to create a multi-time step rolling mean value is three.

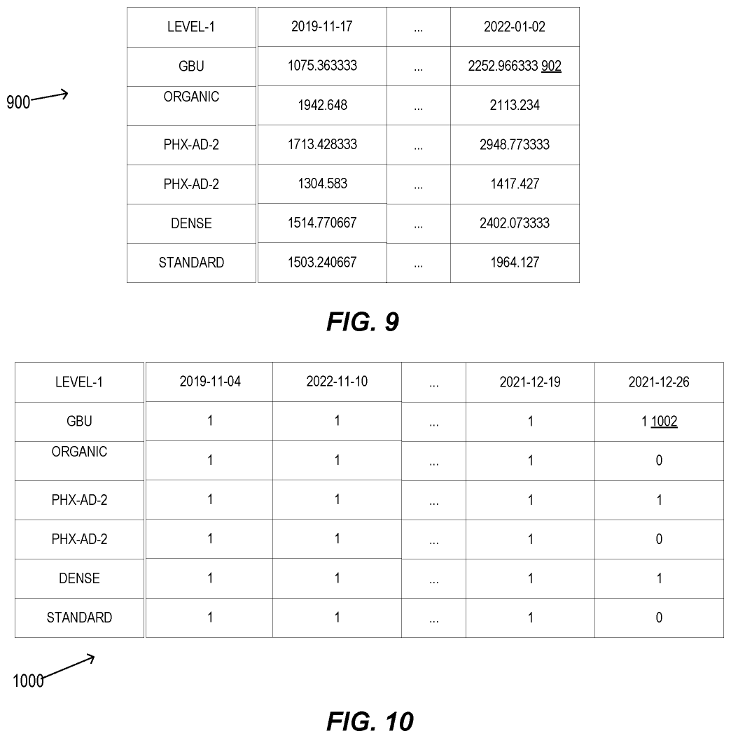

Referring to FIG. 9, a table 900 for multi-time step rolling mean values is shown according to embodiments. The time steps in the table 900 begin on Nov. 17, 2019 and end on Jan. 2, 2022. The table 900 includes values calculated by adding together previous time step values from the time-varying feature table 600 and dividing the sum by the number of previous time steps. The calculated multi-time step rolling mean value can be included as the next time step. For example, consider a situation in which the machine learning forecasting model can be tasked with forecasting three time steps. Therefore, the number of previous time steps used to calculate a multi-time step rolling mean value is three. Referring back to FIG. 7, the Dec. 12, 2021 value 706 for GBU is 2213.899, the Dec. 19, 2021 value 708 for the client GBU is 2232.291, and the Dec. 26, 2021 value 710 for the client GBU is 2312.709. The computing device can calculate a sum for the three previous time steps (2213.899+2232.291+2312.709) and arrive at a sum of 6758.899. The computing device can then divide the sum by the number of previous time steps used to calculate the sum (6758.899/3) and arrive at a value of 2252.966333. The value can be inserted in a next time step in the table 900. As seen in FIG. 9, the table 900 includes the Jan. 2, 2022 value 902 for the client GBU of 2252.966333. Furthermore, Jan. 2, 2022, is the next time step after Dec. 26, 2021, which is the last time step value used to calculate the multi-time step rolling mean value of 2252.966333.

The computing device can further use feature engineering to create time-varying directional features using values from the time-varying feature table 600. The computing device can compare two values in a series to determine the directional feature. For example, the computing device can detect two sequential values from time-series data. The computing device can further compare the two values to determine whether the later in time value increased or decreased. If the later in time value is greater than the earlier in time value, the computing device can assign a value to indicate an increasing direction. If, however, the computing device determines that the later in time value is lower than the earlier in time value, the computing device can assign a value to indicate a decreasing direction.

Referring to FIG. 10, a table 1000 illustrating the time-varying directional features is shown according to embodiments. The time steps in the table 1000 begin on Nov. 4, 2019, and end on Dec. 26, 2021. The computing device can compare two sequential time step values. For example, the Dec. 19, 2021 value 708 for the client GBU is 2232.291 and the Dec. 26, 2021 value 710 for the client GBU is 2312.709. The computing device can compare the Dec. 19, 2021 value 708 for the client GBU and the Dec. 26, 2021 value 710 for the client GBU. The computing device can further determine that the Dec. 26, 2021 value 710 for the client GBU is greater than the Dec. 19, 2021 value 708. In response to the determination, the computing device can enter a Dec. 26, 2021 value for the client GBU to indicate that the direction is increasing. As illustrated, the computing device enters a “1” to indicate an increasing direction. In another instance, the computing device can compare the Dec. 19, 2021 value 712 (2119.007) for the client organic and the Dec. 26, 2021 value 714 (2104.329) for the client organic. In this instance, the Dec. 26, 2021 value 714 for the client organic is less than the Dec. 19, 2021 value 712 for the client organic. Therefore, the computing device can enter a Dec. 19, 2021 value for the client GBU to indicate that the direction is decreasing. As illustrated, the computing device enters a “0” to indicate a decreasing direction.

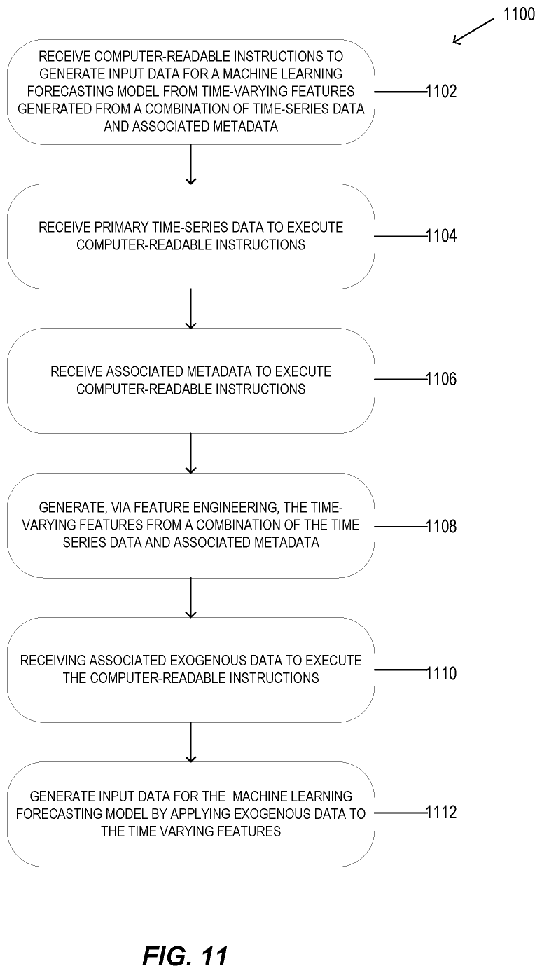

Referring to FIG. 11, an exemplary method 1100 for time-varying feature generation according to one or more embodiments is shown. The operations of processes 1100 and 1200 may be performed by any suitable computing device (e.g., a user device, a server device, a controller device, a resident device, or the like) and may be used to perform one or more operations of these processes. Processes 1100 and 1200 (described below) are illustrated as logical flow diagrams, each operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

At 1102, a computing device can receive computer-readable instructions to generate input data for a machine learning forecasting model. The computer-readable instructions can further direct the computing device to generate the input data from time-varying features and exogenous data.

At 1104, the computing device can receive the time-series data to execute the computer-readable instructions. The time-series data can be data described by one or more time-series. For example, the time-series data can be five years' worth of monthly performance data for a server. In this example, the time-series data can be a set of five time-series of monthly performance data.

At 1106, the computing device can receive the metadata to execute the computer-readable instructions. The metadata can be data that provides information describing the time-series data. Continuing from the example above, the metadata can be a datacenter location for the server, a network that the server can be connected to, or an identification of a hardware type of the server.

At 1108, the computing device can perform feature engineering to generate the time-varying features from the time-series data. The computing device can discover relationships between values of the time-series data based on the metadata. The computing device can further combine related values of the time-series data to generate time-varying features that describe temporal relationships between the values in the time-series data.

At 1110 the computing device can receive exogenous data to execute the computer-readable instructions. The exogenous data can be data that is not influenced by the time-series data. The exogenous data can, however, influence the values of the time-series data. Continuing with the example above, the exogenous data can be temperature data. In times of extreme cold or extreme heat, the server's performance can be affected. However, the server's performance never determines what the temperature is.

At 1112, the computing device can generate the input data for the machine learning forecasting model by applying the exogenous data to the time-varying features. The computing device can use various techniques to apply the exogenous data to the time-varying features.

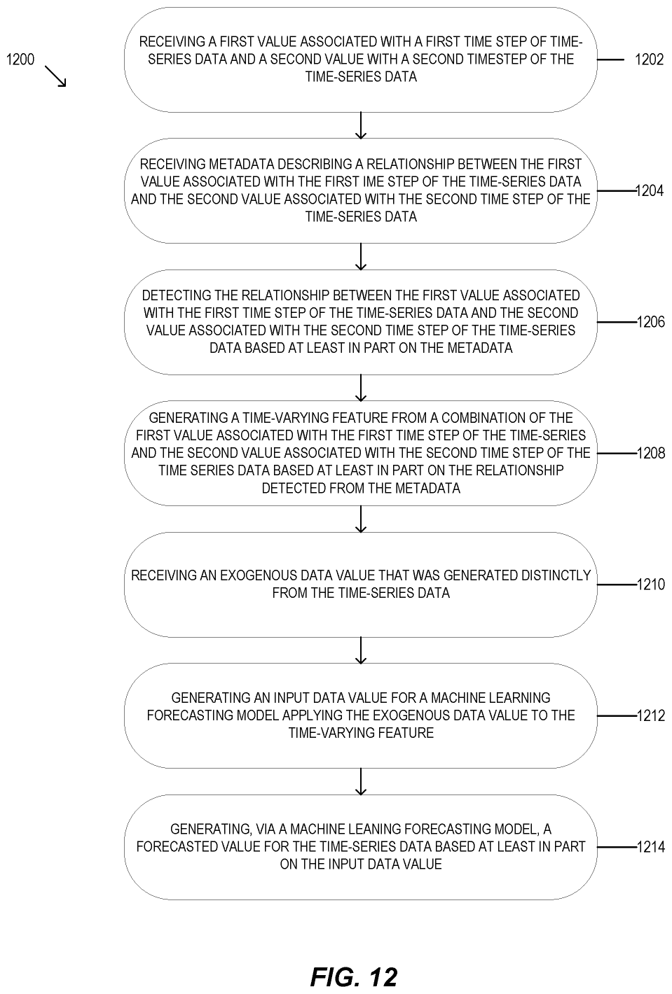

Referring to FIG. 12, an exemplary method 1200 for time-varying feature generation according to one or more embodiments is shown. At 1202, a computing device can receive a first value associated with a first time step of time-series data and a second value associated with a second timestep of the time-series data. The time-series data can be received in table format and include one or more time-series.

At 1204, the computing device can receive metadata that describes a relationship between the first value associated with the first time step of the time-series data and the second value associated with the second time step of the time-series data. The metadata can be generated based at least in part on the time-series data. As the values for the time-series data are being collected, the metadata can be collected. For example, as a server's performance parameter values are being collected, the identity of the server and descriptions of the tasks performed by the server can also be collected.

At 1206, the computing device can detect the relationship between the first value associated with the first time step of the time-series data and the second value associated with the second time step of the time-series data based at least in part on the metadata. For example, in an instance in which different time-series values are associated with different metadata. The computing device can detect relationships between different time-series based on the metadata.

At 1208, the computing device can generate a time-varying feature from a combination of the first value associated with the first time step of the time-series data and the second value associated with the second time step of the time-series data based at least in part on the relationship detected from the metadata. The time-varying feature can be, for example, based on a sum of the first value associated with the first time step of the time-series data and the second value associated with the second time step of the time-series data, based on a lag length, or based on a multi-time step rolling mean value.

At 1210, the computing device can receive an exogenous data value. The exogenous data value can be generated distinctly from the time-series data. For example, if the time-series data relates to a server's performance, the exogenous data value can be related to temperature values.

At 1212, the computing device can generate an input data value for a machine learning forecasting model by applying the exogenous data value to the time-varying feature. The input data can be a value appropriate for consumption by the machine learning forecasting model.

At 1214, the computing device can generate, by implementing the machine learning forecasting model, a forecasted value for the time-series data based at least in part on the input data value.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing, and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may first need to be set up. In some instances, the provisioning can be done manually, a provisioning tool may be utilized to provision the resources, and/or deployment tools may be utilized to deploy the code once the infrastructure is provisioned.

FIG. 12 is a block diagram 1200 illustrating an example pattern of an IaaS architecture, according to at least one embodiment. Service operators 1202 can be communicatively coupled to a secure host tenancy 1204 that can include a virtual cloud network (VCN) 1206 and a secure host subnet 1208. In some examples, the service operators 1202 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 14, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1206 and/or the Internet.

The VCN 1206 can include a local peering gateway (LPG) 1210 that can be communicatively coupled to a secure shell (SSH) VCN 1212 via an LPG 1210 contained in the SSH VCN 1212. The SSH VCN 1212 can include an SSH subnet 1214, and the SSH VCN 1212 can be communicatively coupled to a control plane VCN 1216 via the LPG 1210 contained in the control plane VCN 1216. Also, the SSH VCN 1212 can be communicatively coupled to a data plane VCN 1218 via an LPG 1210. The control plane VCN 1216 and the data plane VCN 1218 can be contained in a service tenancy 1219 that can be owned and/or operated by the IaaS provider.

The control plane VCN 1216 can include a control plane demilitarized zone (DMZ) tier 1220 that acts as a perimeter network (e.g., portions of a corporate network between the corporate intranet and external networks). The DMZ-based servers may have restricted responsibilities and help keep breaches contained. Additionally, the DMZ tier 1220 can include one or more load balancer (LB) subnet(s) 1222, a control plane app tier 1224 that can include app subnet(s) 1226, a control plane data tier 1228 that can include database (DB) subnet(s) 1230 (e.g., frontend DB subnet(s) and/or backend DB subnet(s)). The LB subnet(s) 1222 contained in the control plane DMZ tier 1220 can be communicatively coupled to the app subnet(s) 1226 contained in the control plane app tier 1224 and an Internet gateway 1234 that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238. The control plane VCN 1216 can include the service gateway 1236 and the NAT gateway 1238.

The control plane VCN 1216 can include a data plane mirror app tier 1240 that can include app subnet(s) 1226. The app subnet(s) 1226 contained in the data plane mirror app tier 1240 can include a virtual network interface controller (VNIC) 1242 that can execute a compute instance 1244. The compute instance 1244 can communicatively couple the app subnet(s) 1226 of the data plane mirror app tier 1240 to app subnet(s) 1226 that can be contained in a data plane app tier 1246.

The data plane VCN 1218 can include the data plane app tier 1246, a data plane DMZ tier 1248, and a data plane data tier 1250. The data plane DMZ tier 1248 can include LB subnet(s) 1222 that can be communicatively coupled to the app subnet(s) 1226 of the data plane app tier 1246 and the Internet gateway 1234 of the data plane VCN 1218. The app subnet(s) 1226 can be communicatively coupled to the service gateway 1236 of the data plane VCN 1218 and the NAT gateway 1238 of the data plane VCN 1218. The data plane data tier 1250 can also include the DB subnet(s) 1230 that can be communicatively coupled to the app subnet(s) 1226 of the data plane app tier 1246.

The Internet gateway 1234 of the control plane VCN 1216 and of the data plane VCN 1218 can be communicatively coupled to a metadata management service 1252 that can be communicatively coupled to public Internet 1254. Public Internet 1254 can be communicatively coupled to the NAT gateway 1238 of the control plane VCN 1216 and of the data plane VCN 1218. The service gateway 1236 of the control plane VCN 1216 and of the data plane VCN 1218 can be communicatively couple to cloud services 1256.

In some examples, the service gateway 1236 of the control plane VCN 1216 or of the data plane VCN 1218 can make application programming interface (API) calls to cloud services 1256 without going through public Internet 1254. The API calls to cloud services 1256 from the service gateway 1236 can be one-way: the service gateway 1236 can make API calls to cloud services 1256, and cloud services 1256 can send requested data to the service gateway 1236. But, cloud services 1256 may not initiate API calls to the service gateway 1236.

In some examples, the secure host tenancy 1204 can be directly connected to the service tenancy 1219, which may be otherwise isolated. The secure host subnet 1208 can communicate with the SSH subnet 1214 through an LPG 1210 that may enable two-way communication over an otherwise isolated system. Connecting the secure host subnet 1208 to the SSH subnet 1214 may give the secure host subnet 1208 access to other entities within the service tenancy 1219.

The control plane VCN 1216 may allow users of the service tenancy 1219 to set up or otherwise provision desired resources. Desired resources provisioned in the control plane VCN 1216 may be deployed or otherwise used in the data plane VCN 1218. In some examples, the control plane VCN 1216 can be isolated from the data plane VCN 1218, and the data plane mirror app tier 1240 of the control plane VCN 1216 can communicate with the data plane app tier 1246 of the data plane VCN 1218 via VNICs 1242 that can be contained in the data plane mirror app tier 1240 and the data plane app tier 1246.

In some examples, users of the system, or customers, can make requests, for example create, read, update, or delete (CRUD) operations, through public Internet 1254 that can communicate the requests to the metadata management service 1252. The metadata management service 1252 can communicate the request to the control plane VCN 1216 through the Internet gateway 1234. The request can be received by the LB subnet(s) 1222 contained in the control plane DMZ tier 1220. The LB subnet(s) 1222 may determine that the request is valid, and in response to this determination, the LB subnet(s) 1222 can transmit the request to app subnet(s) 1226 contained in the control plane app tier 1224. If the request is validated and requires a call to public Internet 1254, the call to public Internet 1254 may be transmitted to the NAT gateway 1238 that can make the call to public Internet 1254. Memory that may be desired to be stored by the request can be stored in the DB subnet(s) 1230.

In some examples, the data plane mirror app tier 1240 can facilitate direct communication between the control plane VCN 1216 and the data plane VCN 1218. For example, changes, updates, or other suitable modifications to configuration may be desired to be applied to the resources contained in the data plane VCN 1218. Via a VNIC 1242, the control plane VCN 1216 can directly communicate with, and can thereby execute the changes, updates, or other suitable modifications to configuration to, resources contained in the data plane VCN 1218.

In some embodiments, the control plane VCN 1216 and the data plane VCN 1218 can be contained in the service tenancy 1219. In this case, the user, or the customer, of the system may not own or operate either the control plane VCN 1216 or the data plane VCN 1218. Instead, the IaaS provider may own or operate the control plane VCN 1216 and the data plane VCN 1218, both of which may be contained in the service tenancy 1219. This embodiment can enable isolation of networks that may prevent users or customers from interacting with other users′, or other customers′, resources. Also, this embodiment may allow users or customers of the system to store databases privately without needing to rely on public Internet 1254, which may not have a desired level of threat prevention, for storage.

In other embodiments, the LB subnet(s) 1222 contained in the control plane VCN 1216 can be configured to receive a signal from the service gateway 1236. In this embodiment, the control plane VCN 1216 and the data plane VCN 1218 may be configured to be called by a customer of the IaaS provider without calling public Internet 1254. Customers of the IaaS provider may desire this embodiment since database(s) that the customers use may be controlled by the IaaS provider and may be stored on the service tenancy 1219, which may be isolated from public Internet 1254.

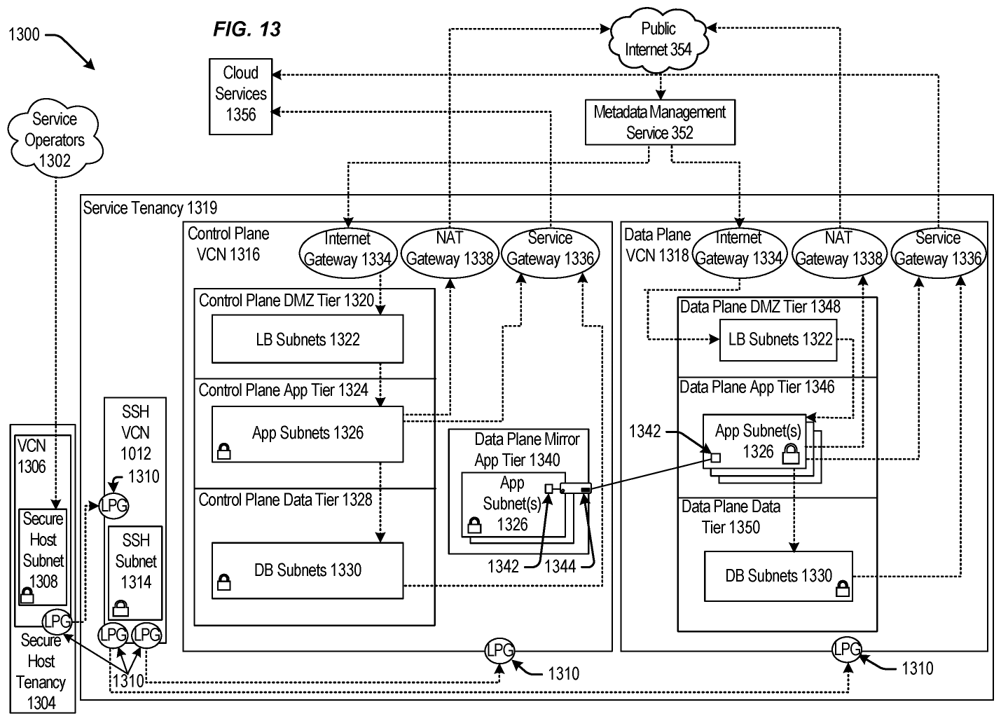

FIG. 13 is a block diagram 1300 illustrating another example pattern of an IaaS architecture, according to at least one embodiment. Service operators 1302 (e.g., service operators 1202 of FIG. 12) can be communicatively coupled to a secure host tenancy 1304 (e.g., the secure host tenancy 1204 of FIG. 12) that can include a virtual cloud network (VCN) 1306 (e.g., the VCN 1206 of FIG. 12) and a secure host subnet 1308 (e.g., the secure host subnet 1208 of FIG. 12). The VCN 1376 can include a local peering gateway (LPG) 1310 (e.g., the LPG 1210 of FIG. 12) that can be communicatively coupled to a secure shell (SSH) VCN 1312 (e.g., the SSH VCN 1212 of FIG. 12) via an LPG 1310 contained in the SSH VCN 1312. The SSH VCN 1312 can include an SSH subnet 1314 (e.g., the SSH subnet 1214 of FIG. 12), and the SSH VCN 1312 can be communicatively coupled to a control plane VCN 1316 (e.g., the control plane VCN 1216 of FIG. 12) via an LPG 1310 contained in the control plane VCN 1316. The control plane VCN 1316 can be contained in a service tenancy 1319 (e.g., the service tenancy 1219 of FIG. 12), and the data plane VCN 1318 (e.g., the data plane VCN 1218 of FIG. 12) can be contained in a customer tenancy 1321 that may be owned or operated by users, or customers, of the system.

The control plane VCN 1316 can include a control plane DMZ tier 1320 (e.g., the control plane DMZ tier 1220 of FIG. 12) that can include LB subnet(s) 1322 (e.g., LB subnet(s) 1222 of FIG. 12), a control plane app tier 1324 (e.g., the control plane app tier 1224 of FIG. 12) that can include app subnet(s) 1326 (e.g., app subnet(s) 1226 of FIG. 12), a control plane data tier 1328 (e.g., the control plane data tier 1228 of FIG. 12) that can include database (DB) subnet(s) 1330 (e.g., similar to DB subnet(s) 1230 of FIG. 12). The LB subnet(s) 1322 contained in the control plane DMZ tier 1320 can be communicatively coupled to the app subnet(s) 1326 contained in the control plane app tier 1324 and an Internet gateway 1334 (e.g., the Internet gateway 1234 of FIG. 12) that can be contained in the control plane VCN 1316, and the app subnet(s) 1326 can be communicatively coupled to the DB subnet(s) 1330 contained in the control plane data tier 1328 and a service gateway 1336 (e.g., the service gateway 1236 of FIG. 12) and a network address translation (NAT) gateway 1338 (e.g., the NAT gateway 1238 of FIG. 12). The control plane VCN 1316 can include the service gateway 1336 and the NAT gateway 1338.

The control plane VCN 1316 can include a data plane mirror app tier 1340 (e.g., the data plane mirror app tier 1240 of FIG. 12) that can include app subnet(s) 1326. The app subnet(s) 1326 contained in the data plane mirror app tier 1340 can include a virtual network interface controller (VNIC) 1342 (e.g., the VNIC of 1242 of FIG. 12) that can execute a compute instance 1344 (e.g., similar to the compute instance 1244 of FIG. 12). The compute instance 1344 can facilitate communication between the app subnet(s) 1326 of the data plane mirror app tier 1340 and the app subnet(s) 1326 that can be contained in a data plane app tier 1346 (e.g., the data plane app tier 1346 of FIG. 13) via the VNIC 1342 contained in the data plane mirror app tier 1340 and the VNIC 1342 contained in the data plane app tier 1346.

The Internet gateway 1334 contained in the control plane VCN 1316 can be communicatively coupled to a metadata management service 1352 (e.g., the metadata management service 1202 of FIG. 12) that can be communicatively coupled to public Internet 1354 (e.g., public Internet 1204 of FIG. 12). Public Internet 1354 can be communicatively coupled to the NAT gateway 1338 contained in the control plane VCN 1316. The service gateway 1336 contained in the control plane VCN 1316 can be communicatively couple to cloud services 1356 (e.g., cloud services 1256 of FIG. 12).

In some examples, the data plane VCN 1318 can be contained in the customer tenancy 1321. In this case, the IaaS provider may provide the control plane VCN 1316 for each customer, and the IaaS provider may, for each customer, set up a unique compute instance 1344 that is contained in the service tenancy 1319. Each compute instance 1344 may allow communication between the control plane VCN 1316, contained in the service tenancy 1319, and the data plane VCN 1318 that is contained in the customer tenancy 1321. The compute instance 1344 may allow resources, that are provisioned in the control plane VCN 1316 that is contained in the service tenancy 1319, to be deployed or otherwise used in the data plane VCN 1318 that is contained in the customer tenancy 1321.

In other examples, the customer of the IaaS provider may have databases that live in the customer tenancy 1321. In this example, the control plane VCN 1316 can include the data plane mirror app tier 1340 that can include app subnet(s) 1326. The data plane mirror app tier 1340 can reside in the data plane VCN 1318, but the data plane mirror app tier 1340 may not live in the data plane VCN 1318. That is, the data plane mirror app tier 1340 may have access to the customer tenancy 1321, but the data plane mirror app tier 1340 may not exist in the data plane VCN 1318 or be owned or operated by the customer of the IaaS provider. The data plane mirror app tier 1340 may be configured to make calls to the data plane VCN 1318 but may not be configured to make calls to any entity contained in the control plane VCN 1316. The customer may desire to deploy or otherwise use resources in the data plane VCN 1318 that are provisioned in the control plane VCN 1316, and the data plane mirror app tier 1340 can facilitate the desired deployment, or other usage of resources, of the customer.

In some embodiments, the customer of the IaaS provider can apply filters to the data plane VCN 1318. In this embodiment, the customer can determine what the data plane VCN 1318 can access, and the customer may restrict access to public Internet 1354 from the data plane VCN 1318. The IaaS provider may not be able to apply filters or otherwise control access of the data plane VCN 1318 to any outside networks or databases. Applying filters and controls by the customer onto the data plane VCN 1318, contained in the customer tenancy 1321, can help isolate the data plane VCN 1318 from other customers and from public Internet 1354.

In some embodiments, cloud services 1356 can be called by the service gateway 1336 to access services that may not exist on public Internet 1354, on the control plane VCN 1316, or on the data plane VCN 1318. The connection between cloud services 1356 and the control plane VCN 1316 or the data plane VCN 1318 may not be live or continuous. Cloud services 1356 may exist on a different network owned or operated by the IaaS provider. Cloud services 1356 may be configured to receive calls from the service gateway 1336 and may be configured to not receive calls from public Internet 1354. Some cloud services 1356 may be isolated from other cloud services 1356, and the control plane VCN 1316 may be isolated from cloud services 1356 that may not be in the same region as the control plane VCN 1316. For example, the control plane VCN 1316 may be located in “Region 1,” and cloud service “Deployment 1,” may be located in Region 1 and in “Region 2.” If a call to Deployment 1 is made by the service gateway 1336 contained in the control plane VCN 1316 located in Region 1, the call may be transmitted to Deployment 1 in Region 1. In this example, the control plane VCN 1316, or Deployment 1 in Region 1, may not be communicatively coupled to, or otherwise in communication with, Deployment 2 in Region 2.

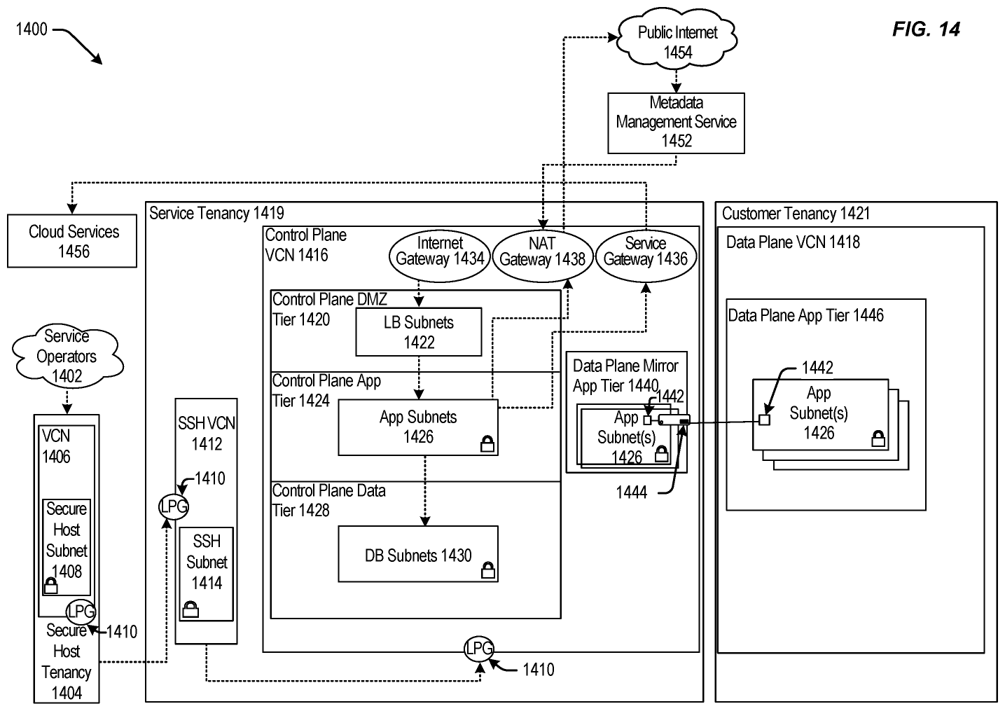

FIG. 14 is a block diagram 1400 illustrating another example pattern of an IaaS architecture, according to at least one embodiment. Service operators 1402 (e.g., service operators 1202 of FIG. 12) can be communicatively coupled to a secure host tenancy 1404 (e.g., the secure host tenancy 1204 of FIG. 12) that can include a virtual cloud network (VCN) 1406 (e.g., the VCN 1406 of FIG. 12) and a secure host subnet 1408 (e.g., the secure host subnet 1208 of FIG. 12). The VCN 1406 can include an LPG 1410 (e.g., the LPG 1210 of FIG. 12) that can be communicatively coupled to an SSH VCN 1412 (e.g., the SSH VCN 1212 of FIG. 12) via an LPG 1410 contained in the SSH VCN 1412. The SSH VCN 1412 can include an SSH subnet 1414 (e.g., the SSH subnet 1214 of FIG. 12), and the SSH VCN 1412 can be communicatively coupled to a control plane VCN 1416 (e.g., the control plane VCN 1216 of FIG. 12) via an LPG 1410 contained in the control plane VCN 1416 and to a data plane VCN 1418 (e.g., the data plane 1218 of FIG. 12) via an LPG 1410 contained in the data plane VCN 1418. The control plane VCN 1416 and the data plane VCN 1418 can be contained in a service tenancy 1419 (e.g., the service tenancy 1219 of FIG. 12).

The control plane VCN 1416 can include a control plane DMZ tier 1420 (e.g., the control plane DMZ tier 1220 of FIG. 12) that can include load balancer (LB) subnet(s) 1422 (e.g., LB subnet(s) 1222 of FIG. 12), a control plane app tier 1424 (e.g., the control plane app tier 1224 of FIG. 12) that can include app subnet(s) 1426 (e.g., similar to app subnet(s) 1226 of FIG. 12), a control plane data tier 1428 (e.g., the control plane data tier 1228 of FIG. 12) that can include DB subnet(s) 1430. The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1234 of FIG. 12) that can be contained in the control plane VCN 1416, and the app subnet(s) 1426 can be communicatively coupled to the DB subnet(s) 1430 contained in the control plane data tier 1428 and to a service gateway 1436 (e.g., the service gateway 1236 of FIG. 12) and a network address translation (NAT) gateway 1438 (e.g., the NAT gateway 1238 of FIG. 12). The control plane VCN 1416 can include the service gateway 1436 and the NAT gateway 1438.

The data plane VCN 1418 can include a data plane app tier 1446 (e.g., the data plane app tier 1246 of FIG. 12), a data plane DMZ tier 1448 (e.g., the data plane DMZ tier 1248 of FIG. 12), and a data plane data tier 1450 (e.g., the data plane data tier 1250 of FIG. 12). The data plane DMZ tier 1448 can include LB subnet(s) 1422 that can be communicatively coupled to trusted app subnet(s) 1460 and untrusted app subnet(s) 1462 of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include one or more primary VNICs 1464(1)-(N) that can be communicatively coupled to tenant virtual machines (VMs) 1466(1)-(N). Each tenant VM 1466(1)-(N) can be communicatively coupled to a respective app subnet 1467(1)-(N) that can be contained in respective container egress VCNs 1468(1)-(N) that can be contained in respective customer tenancies 1470(1)-(N). Respective secondary VNICs 1472(1)-(N) can facilitate communication between the untrusted app subnet(s) 1462 contained in the data plane VCN 1418 and the app subnet contained in the container egress VCNs 1468(1)-(N). Each container egress VCNs 1468(1)-(N) can include a NAT gateway 1438 that can be communicatively coupled to public Internet 1454 (e.g., public Internet 1254 of FIG. 12). The Internet gateway 1434 contained in the control plane VCN 1416 and contained in the data plane VCN 1418 can be communicatively coupled to a metadata management service 1452 (e.g., the metadata management system 1252 of FIG. 12) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some embodiments, the data plane VCN 1418 can be integrated with customer tenancies 1470. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1446. Code to run the function may be executed in the VMs 1466(1)-(N), and the code may not be configured to run anywhere else on the data plane VCN 1418. Each VM 1466(1)-(N) may be connected to one customer tenancy 1470. Respective containers 1471(1)-(N) contained in the VMs 1466(1)-(N) may be configured to run the code. In this case, there can be a dual isolation (e.g., the containers 1471(1)-(N) running code, where the containers 1471(1)-(N) may be contained in at least the VM 1466(1)-(N) that are contained in the untrusted app subnet(s) 1462), which may help prevent incorrect or otherwise undesirable code from damaging the network of the IaaS provider or from damaging a network of a different customer. The containers 1471(1)-(N) may be communicatively coupled to the customer tenancy 1470 and may be configured to transmit or receive data from the customer tenancy 1470. The containers 1471(1)-(N) may not be configured to transmit or receive data from any other entity in the data plane VCN 1418. Upon completion of running the code, the IaaS provider may kill or otherwise dispose of the containers 1471(1)-(N).

In some embodiments, the trusted app subnet(s) 1460 may run code that may be owned or operated by the IaaS provider. In this embodiment, the trusted app subnet(s) 1460 may be communicatively coupled to the DB subnet(s) 1430 and be configured to execute CRUD operations in the DB subnet(s) 1430. The untrusted app subnet(s) 1462 may be communicatively coupled to the DB subnet(s) 1430, but in this embodiment, the untrusted app subnet(s) may be configured to execute read operations in the DB subnet(s) 1430. The containers 1471(1)-(N) that can be contained in the VM 1466(1)-(N) of each customer and that may run code from the customer may not be communicatively coupled with the DB subnet(s) 1430.

In other embodiments, the control plane VCN 1416 and the data plane VCN 1418 may not be directly communicatively coupled. In this embodiment, there may be no direct communication between the control plane VCN 1416 and the data plane VCN 1418. However, communication can occur indirectly through at least one method. An LPG 1410 may be established by the IaaS provider that can facilitate communication between the control plane VCN 1416 and the data plane VCN 1418. In another example, the control plane VCN 1416 or the data plane VCN 1418 can make a call to cloud services 1456 via the service gateway 1436. For example, a call to cloud services 1456 from the control plane VCN 1416 can include a request for a service that can communicate with the data plane VCN 1418.

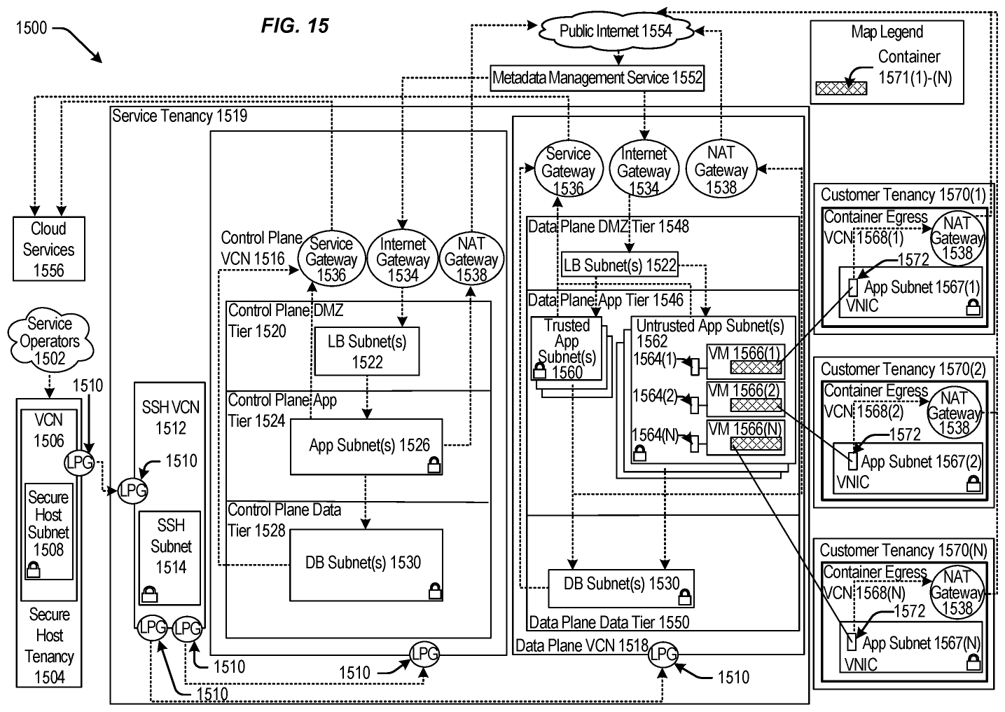

FIG. 15 is a block diagram 1500 illustrating another example pattern of an IaaS architecture, according to at least one embodiment. Service operators 1502 (e.g., service operators 1202 of FIG. 12) can be communicatively coupled to a secure host tenancy 1504 (e.g., the secure host tenancy 1204 of FIG. 12) that can include a virtual cloud network (VCN) 1506 (e.g., the VCN 1206 of FIG. 12) and a secure host subnet 1508 (e.g., the secure host subnet 1208 of FIG. 12). The VCN 1506 can include an LPG 1510 (e.g., the LPG 1210 of FIG. 12) that can be communicatively coupled to an SSH VCN 1512 (e.g., the SSH VCN 1212 of FIG. 12) via an LPG 1510 contained in the SSH VCN 1512. The SSH VCN 1512 can include an SSH subnet 1514 (e.g., the SSH subnet 1214 of FIG. 12), and the SSH VCN 1512 can be communicatively coupled to a control plane VCN 1516 (e.g., the control plane VCN 1216 of FIG. 12) via an LPG 1510 contained in the control plane VCN 1516 and to a data plane VCN 1518 (e.g., the data plane 1218 of FIG. 12) via an LPG 1510 contained in the data plane VCN 1518. The control plane VCN 1516 and the data plane VCN 1518 can be contained in a service tenancy 1519 (e.g., the service tenancy 1219 of FIG. 12).

The control plane VCN 1516 can include a control plane DMZ tier 1520 (e.g., the control plane DMZ tier 1220 of FIG. 12) that can include LB subnet(s) 1522 (e.g., LB subnet(s) 1222 of FIG. 12), a control plane app tier 1524 (e.g., the control plane app tier 1224 of FIG. 12) that can include app subnet(s) 1526 (e.g., app subnet(s) 1226 of FIG. 12), a control plane data tier 1528 (e.g., the control plane data tier 1228 of FIG. 12) that can include DB subnet(s) 1530 (e.g., DB subnet(s) 1230 of FIG. 12). The LB subnet(s) 1522 contained in the control plane DMZ tier 1520 can be communicatively coupled to the app subnet(s) 1526 contained in the control plane app tier 1524 and to an Internet gateway 1534 (e.g., the Internet gateway 1234 of FIG. 12) that can be contained in the control plane VCN 1516, and the app subnet(s) 1526 can be communicatively coupled to the DB subnet(s) 1530 contained in the control plane data tier 1528 and to a service gateway 1536 (e.g., the service gateway 1236 of FIG. 12) and a network address translation (NAT) gateway 1538 (e.g., the NAT gateway 1238 of FIG. 12). The control plane VCN 1516 can include the service gateway 1536 and the NAT gateway 1538.

The data plane VCN 1518 can include a data plane app tier 1546 (e.g., the data plane app tier 1246 of FIG. 12), a data plane DMZ tier 1548 (e.g., the data plane DMZ tier 1248 of FIG. 12), and a data plane data tier 1550 (e.g., the data plane data tier 1250 of FIG. 12). The data plane DMZ tier 1548 can include LB subnet(s) 1522 that can be communicatively coupled to trusted app subnet(s) 1560 (e.g., trusted app subnet(s) 1460 of FIG. 14) and untrusted app subnet(s) 1562 (e.g., untrusted app subnet(s) 1462 of FIG. 14) of the data plane app tier 1546 and the Internet gateway 1534 contained in the data plane VCN 1518. The trusted app subnet(s) 1560 can be communicatively coupled to the service gateway 1536 contained in the data plane VCN 1518, the NAT gateway 1538 contained in the data plane VCN 1518, and DB subnet(s) 1530 contained in the data plane data tier 1550. The untrusted app subnet(s) 1562 can be communicatively coupled to the service gateway 1536 contained in the data plane VCN 1518 and DB subnet(s) 1530 contained in the data plane data tier 1550. The data plane data tier 1550 can include DB subnet(s) 1530 that can be communicatively coupled to the service gateway 1536 contained in the data plane VCN 1518.

The untrusted app subnet(s) 1562 can include primary VNICs 1564(1)-(N) that can be communicatively coupled to tenant virtual machines (VMs) 1566(1)-(N) residing within the untrusted app subnet(s) 1562. Each tenant VM 1566(1)-(N) can run code in a respective container 1567(1)-(N), and be communicatively coupled to an app subnet 1526 that can be contained in a data plane app tier 1546 that can be contained in a container egress VCN 1568. Respective secondary VNICs 1572(1)-(N) can facilitate communication between the untrusted app subnet(s) 1562 contained in the data plane VCN 1518 and the app subnet contained in the container egress VCN 1568. The container egress VCN can include a NAT gateway 1538 that can be communicatively coupled to public Internet 1554 (e.g., public Internet 1254 of FIG. 12).

The Internet gateway 1534 contained in the control plane VCN 1516 and contained in the data plane VCN 1518 can be communicatively coupled to a metadata management service 1552 (e.g., the metadata management system 1252 of FIG. 12) that can be communicatively coupled to public Internet 1554. Public Internet 1554 can be communicatively coupled to the NAT gateway 1538 contained in the control plane VCN 1516 and contained in the data plane VCN 1518. The service gateway 1536 contained in the control plane VCN 1516 and contained in the data plane VCN 1518 can be communicatively couple to cloud services 1556.

In some examples, the pattern illustrated by the architecture of block diagram 1500 of FIG. 15 may be considered an exception to the pattern illustrated by the architecture of block diagram 1400 of FIG. 14 and may be desirable for a customer of the IaaS provider if the IaaS provider cannot directly communicate with the customer (e.g., a disconnected region). The respective containers 1567(1)-(N) that are contained in the VMs 1566(1)-(N) for each customer can be accessed in real-time by the customer. The containers 1567(1)-(N) may be configured to make calls to respective secondary VNICs 1572(1)-(N) contained in app subnet(s) 1526 of the data plane app tier 1546 that can be contained in the container egress VCN 1568. The secondary VNICs 1572(1)-(N) can transmit the calls to the NAT gateway 1538 that may transmit the calls to public Internet 1554. In this example, the containers 1567(1)-(N) that can be accessed in real-time by the customer can be isolated from the control plane VCN 1516 and can be isolated from other entities contained in the data plane VCN 1518. The containers 1567(1)-(N) may also be isolated from resources from other customers.

In other examples, the customer can use the containers 1567(1)-(N) to call cloud services 1556. In this example, the customer may run code in the containers 1567(1)-(N) that requests a service from cloud services 1556. The containers 1567(1)-(N) can transmit this request to the secondary VNICs 1572(1)-(N) that can transmit the request to the NAT gateway that can transmit the request to public Internet 1554. Public Internet 1554 can transmit the request to LB subnet(s) 1522 contained in the control plane VCN 1516 via the Internet gateway 1534. In response to determining the request is valid, the LB subnet(s) can transmit the request to app subnet(s) 1526 that can transmit the request to cloud services 1556 via the service gateway 1536.

It should be appreciated that IaaS architectures 1200, 1300, 1400, 1500 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

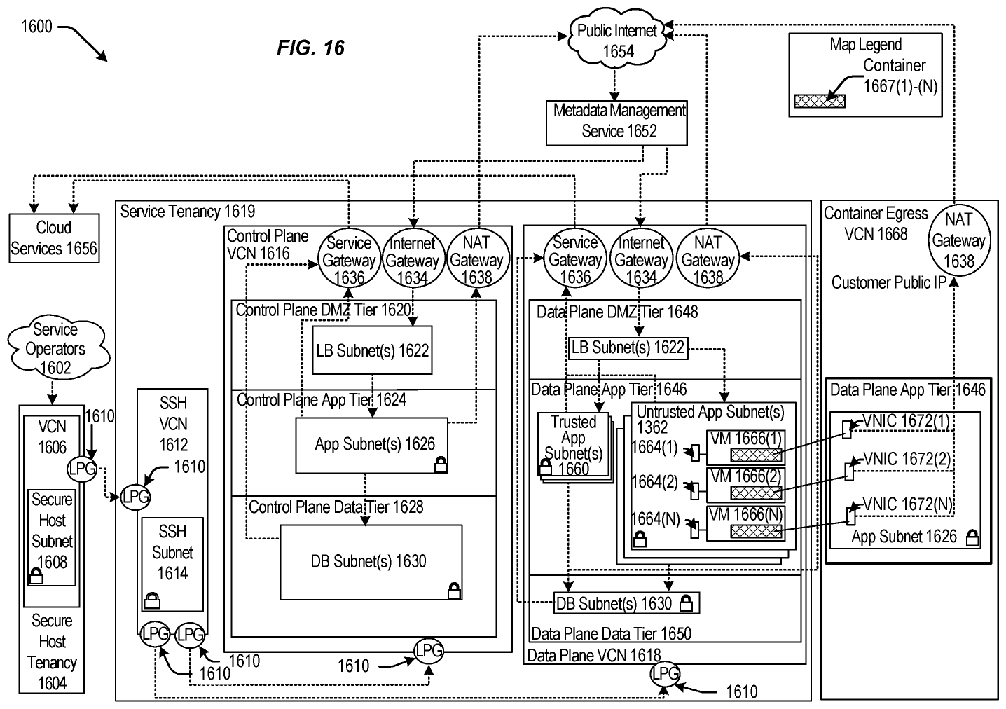

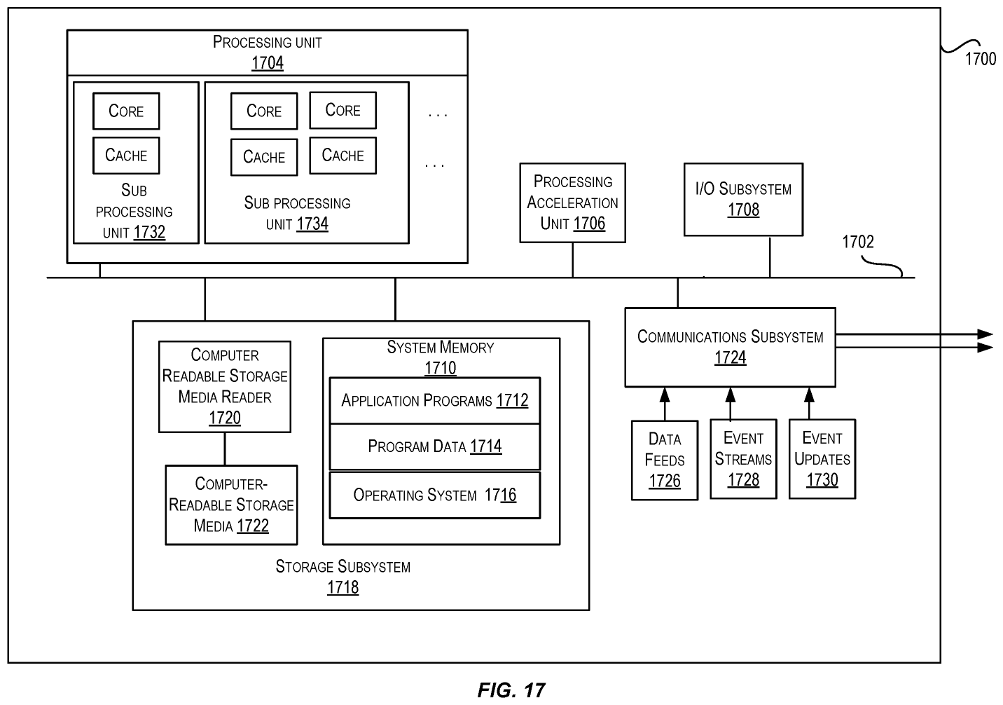

FIG. 16 illustrates an example computer system 1600, in which various embodiments may be implemented. The system 1600 may be used to implement any of the computer systems described above. As shown in the figure, computer system 1600 includes a processing unit 1604 that communicates with a number of peripheral subsystems via a bus subsystem 1602. These peripheral subsystems may include a processing acceleration unit 1606, an I/O subsystem 1608, a storage subsystem 1618 and a communications subsystem 1624. Storage subsystem 1618 includes tangible computer-readable storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative embodiments of the bus subsystem may utilize multiple buses. Bus subsystem 1602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1604, which can be implemented as one or more integrated circuits (e.g., a conventional microprocessor or microcontroller), controls the operation of computer system 1600. One or more processors may be included in processing unit 1604. These processors may include single core or multicore processors. In certain embodiments, processing unit 1604 may be implemented as one or more independent processing units 1632 and/or 1634 with single or multicore processors included in each processing unit. In other embodiments, processing unit 1604 may also be implemented as a quad-core processing unit formed by integrating two dual-core processors into a single chip.

In various embodiments, processing unit 1604 can execute a variety of programs in response to program code and can maintain multiple concurrently executing programs or processes. At any given time, some or all of the program code to be executed can be resident in processor(s) 1604 and/or in storage subsystem 1618. Through suitable programming, processor(s) 1604 can provide various functionalities described above. Computer system 1600 may additionally include a processing acceleration unit 1606, which can include a digital signal processor (DSP), a special-purpose processor, and/or the like.

I/O subsystem 1608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1600 may comprise a storage subsystem 1618 that comprises software elements, shown as being currently located within a system memory 1610. System memory 1610 may store program instructions that are loadable and executable on processing unit 1604, as well as data generated during the execution of these programs.

Depending on the configuration and type of computer system 1600, system memory 1610 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1604. In some implementations, system memory 1610 may include multiple different types of memory, such as static random access memory (SRAM) or dynamic random access memory (DRAM). In some implementations, a basic input/output system (BIOS), containing the basic routines that help to transfer information between elements within computer system 1600, such as during start-up, may typically be stored in the ROM. By way of example, and not limitation, system memory 1610 also illustrates application programs 1612, which may include client applications, Web browsers, mid-tier applications, relational database management systems (RDBMS), etc., program data 1614, and an operating system 1616. By way of example, operating system 1616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1618 may also provide a tangible computer-readable storage medium for storing the basic programming and data constructs that provide the functionality of some embodiments. Software (programs, code modules, instructions) that when executed by a processor provide the functionality described above may be stored in storage subsystem 1618. These software modules or instructions may be executed by processing unit 1604. Storage subsystem 1618 may also provide a repository for storing data used in accordance with the present disclosure.

Storage subsystem 1600 may also include a computer-readable storage media reader 1620 that can further be connected to computer-readable storage media 1622. Together and, optionally, in combination with system memory 1610, computer-readable storage media 1622 may comprehensively represent remote, local, fixed, and/or removable storage devices plus storage media for temporarily and/or more permanently containing, storing, transmitting, and retrieving computer-readable information.

Computer-readable storage media 1622 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by computing system 1600.

By way of example, computer-readable storage media 1622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1600.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to connect to one or more devices via the Internet. In some embodiments communications subsystem %524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 302.11 family standards, or other mobile communication technologies, or any combination thereof), global positioning system (GPS) receiver components, and/or other components. In some embodiments communications subsystem 1624 can provide wired network connectivity (e.g., Ethernet) in addition to or instead of a wireless interface.

In some embodiments, communications subsystem 1624 may also receive input communication in the form of structured and/or unstructured data feeds 1626, event streams 1628, event updates 1630, and the like on behalf of one or more users who may use computer system 1600.

By way of example, communications subsystem 1624 may be configured to receive data feeds 1626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1624 may also be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1624 may also be configured to output the structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, the method comprising:
receiving, by a computing device, a first value associated with a first time step of time-series data and a second value associated with a second timestep of the time-series data;
receiving, by the computing device, metadata that describes a relationship between the first value associated with the first time step of the time-series data and the second value associated with the second time step of the time-series data, the metadata being generated based at least in part on the time-series data;
detecting, by the computing device, the relationship between the first value associated with the first time step of the time-series data and the second value associated with the second time step of the time-series data based at least in part on the metadata;
generating, by the computing device, a time-varying feature from a combination of the first value associated with the first time step of the time-series data and the second value associated with the second time step of the time-series data based at least in part on the relationship detected from the metadata;
receiving, by the computing device, an exogenous data value, the exogenous data value being generated distinctly from the time-series data;
generating, by the computing device, an input data value for a machine learning forecasting model by applying the exogenous data value to the time-varying feature; and
generating, by the computing device implementing the machine learning forecasting model, a forecasted value for the time-series data based at least in part on the input data value.

2. The computer-implemented method of claim 1, further comprising transmitting the input data value to the machine learning forecasting model.

3. The computer-implemented method of claim 1, further comprising outputting a local explanation, a global explanation, a fitted series, and a rolling-origin cross-validation error.

4. The computer-implemented method of claim 1, further comprising adding together the first value associated with the first time step of the time-series data and the second value associated with the second time step of the time-series data.

5. The computer-implemented method of claim 1, wherein generating the time-varying feature further comprises:
selecting a lag value;
identifying the second value associated with the second time step of the time-series data based at least in part on the selected lag value; and
combining the first value associated with the first time step of the time-series data and the second value associated with the second time step of the time-series data.

6. The computer-implemented method of claim 1, wherein the machine learning forecasting model implements a gradient boosting technique to generate the forecasted value for the time-series data.

7. The computer-implemented method of claim 1, wherein the time-varying feature comprises a multi-time step rolling mean value.

8. A computing system, comprising:
a processor; and
a computer-readable medium including instructions that, when executed by the processor, cause the processor to:
receive a first value associated with a first time step of time-series data and a second value associated with a second timestep of the time-series data;
receive metadata that describes a relationship between the first value associated with the first time step of the time-series data and the second value associated with the second time step of the time-series data, the metadata being generated based at least in part on the time-series data;
detect the relationship between the first value associated with the first time step of the time-series data and the second value associated with the second time step of the time-series data based at least in part on the metadata;
generate a time-varying feature from a combination of the first value associated with the first time step of the time-series data and the second value associated with the second time step of the time-series data based at least in part on the relationship detected from the metadata;
receive an exogenous data value, the exogenous data value being generated distinctly from the time-series data;
generate an input data value for a machine learning forecasting model by applying the exogenous data value to the time-varying feature; and
generate, by implementing the machine learning forecasting model, a forecasted value for the time-series data based at least in part on the input data value.

9. The computing system of claim 8, wherein the processor further transmits the input data value to the machine learning forecasting model.

10. The computing system of claim 8, wherein the processor further outputs a local explanation, a global explanation, a fitted series, and a rolling-origin cross-validation error.

11. The cloud infrastructure node of claim 8, wherein generating the time-varying feature comprises adding together the first value associated with the first time step of the time-series data and the second value associated with the second time step of the time-series data.

12. The computing system of claim 8, wherein generating the time-varying feature further comprises:
selecting a lag value;
identifying the second value associated with the second time step of the time-series data based at least in part on the selected lag value; and
combining the first value associated with the first time step of the time-series data and the second value associated with the second time step of the time-series data.

13. The computing system of claim 8, wherein the machine learning forecasting model implements a gradient boosting technique to generate the forecasted value for the time-series data.

14. The computing system of claim 8, wherein the time-varying feature comprises a multi-time step rolling mean value.

15. A non-transitory computer-readable medium having stored thereon a sequence of instructions which, when executed by a processor, causes the processor to perform operations comprising:
receiving a first value associated with a first time step of time-series data and a second value associated with a second timestep of the time-series data;
receiving metadata that describes a relationship between the first value associated with the first time step of the time-series data and the second value associated with the second time step of the time-series data, the metadata being generated based at least in part on the time-series data;
detecting the relationship between the first value associated with the first time step of the time-series data and the second value associated with the second time step of the time-series data based at least in part on the metadata;
generating a time-varying feature from a combination of the first value associated with the first time step of the time-series data and the second value associated with the second time step of the time-series data based at least in part on the relationship detected from the metadata;
receiving an exogenous data value, the exogenous data value being generated distinctly from the time-series data;
generating an input data value for a machine learning forecasting model by applying the exogenous data value to the time-varying feature; and
generating, by implementing the machine learning forecasting model, a forecasted value for the time-series data based at least in part on the input data value.

16. The non-transitory computer-readable medium of claim 15, wherein the operations further comprise transmitting the input data value to the machine learning forecasting model.

17. The non-transitory computer-readable medium of claim 15, wherein the operations further comprise outputting a forecasted value based at least in part on the input data, the forecasted value being forecasted from the time-series data.

18. The non-transitory computer-readable medium of claim 15, wherein
generating the time-varying feature comprises adding together the first value associated with the first time step of the time-series data and the second value associated with the second time step of the time-series data.

19. The non-transitory computer-readable medium of claim 15, wherein generating the time-varying feature further comprises:
selecting a lag value;
identifying the second value associated with the second time step of the time-series data based at least in part on the selected lag value; and
combining the first value associated with the first time step of the time-series data and the second value associated with the second time step of the time-series data.

20. The non-transitory computer-readable medium of claim 15, wherein the machine learning forecasting model implements a gradient boosting technique to generate the forecasted value for the time-series data.
